(19) United States
(12) Patent Application Publication
(10) Pub. No.: US 2020/0380612 A1
(43) Pub. Date: Dec. 3, 2020

(54) Legal Task Value Management System

(71) Applicant: Michael L. Derry, Bloomfield Hills, MI (US)

(72) Inventor: Michael L. Derry, Bloomfield Hills, MI (US)

(21) Appl. No.: 16/425,429

(22) Filed: May 29, 2019

(51) Int. Cl. G06Q 40/00; G06F 3/0482; G06Q 50/18

(52) U.S. Cl. CPC G06Q 40/12; G06Q 50/18; G06F 3/0482

(57) ABSTRACT

A legal task value management system provides modules for outline the process of a legal matter, establishing pricing variables for each step of the legal matter. A budget is created and the legal matter is managed by outside counsel based upon the agreed upon and negotiated budget based on dynamically processed data by the legal task value management system. The legal task value management system allows for the exception and variance within the agreed to and approved budget. The legal task value management system creates an invoice based upon the negotiated and agreed upon budget. Statistical reporting provides real-time analysis of all the legal matters within the legal task value management system.

### RELATED U.S. APPLICATION DATA

Provisional application No. 62/678,524, filed on May 31, 2018.

### BACKGROUND OF THE INVENTION

### Field of the Invention

The present invention relates generally to a legal task value management system for use by in-house, corporate counsel, law firms, corporations or individuals to manage all types of case loads, litigation, or regulatory matters, more specifically, an interactive real time system to add and address efficiencies in billing methods, to standardize and streamline the facilitation of budgeting based on different legal strategies and factors, to better control the cost of legal services, automatically generate invoices and allow for factor evaluation and application to budgets for increased budget accuracy and reliability.

### Background and Summary of the Invention

Traditionally the management of legal services involves the client, possibly in-house corporate counsel for the client, outside individual counsel or a law firm handling the matter, and the client, individually or via their in-house or corporate counsel, notifying outside counsel that the client has a legal issue which needs to be resolved. The legal issue can range from a regulatory issue to a lawsuit which has been filed against the client. Outside counsel is then retained by the client and the defense of the lawsuit or path toward regulatory compliance begins. A client may have multiple lawsuits and/or regulatory matters pending simultaneously with multiple different outside counsel in multiple jurisdictions each in various stages of litigation or compliance. During this process, the client may or may not request a budget and each law firm provides the client with a separate budget that the client must negotiate, manage and approve requiring the client to learn, comply with, and accept, with potential reluctance, each outside counsel's method of billing, language variations, and invoicing methods which can vary significantly from basic handwritten invoices to the use of complex software. Clients will often force the outside counsel to use their e-billing system. This client requirement then forces outside counsel to use multiple different e-billing systems for their various clients. Outside counsel will have developed their own billing and invoicing methods as well as billing language variations. Billing language variations occur even if outside counsel has adopted a uniform language to input an attorney's time into the billing software or system utilized by outside counsel; for example, the America Bar Associations' “Uniform Task-Based Management System” (“UTBMS”). The lack of uniformity in attorney narrative creates various inefficiencies for the client. Multiple attorneys will describe the identical task differently. Additionally, the attorney may use different UTBMS activity codes to describe the same task. Any meaningful metrics and data are further distorted when process and phase codes are added, because attorneys may select different codes for the same task throughout the lawsuit or regulatory matter. The result is unreliable data that does not accurately reflect the actual work that has been performed based on the personal selection of codes. Lastly, there is not an activity code for every task that an attorney would complete during a legal matter which forces an attorney to use a code in an unintended manner or develop their own narrative.

Generally, a lawsuit will begin with the filing of a complaint. The person against whom the lawsuit is field (the client) can attempt to enter into settlement discussions rather than partake in the litigation process, and if unable to settle, may decide to answer the complaint or file a motion in response to the complaint. If the lawsuit is not dismissed on a motion, then the lawsuit will move into the discovery phase of litigation. Various motions can be filed during the litigation process. If the client is unable to have the lawsuit dismissed or settled, the lawsuit will proceed to trial. Depending on the outcome of the trial, the client may engage in various post-trial motions or appeal the decision to a higher court. Each one of these various stages of litigation comes at a cost to the client, which the client may or may not require a budget in advance of the performance of the work.

How a lawsuit or regulatory matter is managed by a law firm varies drastically from no management system, leaving the client to the communication and management whim of the attorney directly handling the matter, to complex case management software. Often a client is forced to deal with the communication style of the attorney who is handling their lawsuit or regulatory matter. For example, if the attorney has no management system for their lawsuits or regulatory matters, the client will not receive consistent, regular communications from the attorney regarding the status of the lawsuit or regulatory matter and the client will not be provided a copy of the work-product developed and filed on behalf of the client, unless specifically requested by the client. Worse yet, the client could be forced to contend with multiple different complex case management software systems if the client does not have a case management system that the client requires outside counsel to use.

If the client does use a case management system, outside counsel is forced to use that system. This results in the client having one case management system, while outside counsel will often have to use multiple different case management systems for their variety of clients. The case management system used by the client will only be useful for case status and not billing management or invoice generation, but only if an attorney takes the additional time to use the software to provide case status to the client in addition to the input of the attorney's time in conformance with the law firm's separate billing method.

Law firm and individual attorney management styles, an attorney's experience level, the attorney's hourly rate, opposing counsel's reputation and experience level, jurisdiction, judge assignment and type of lawsuit and/or regulatory matter will all factor into the overall cost of the lawsuit or regulatory matter to the client. When a law firm determines an appropriate budget for the lawsuit or regulatory matter, the law firm absolutely should take into account all of these factors and more. There is currently no mechanism for a law firm or attorney to accurately prepare a budget for a lawsuit or regulatory matter while taking into account any factors, including the small list above, which will have a drastic effect on the overall accuracy of the budget. There is currently not a mechanism to track the overall effect on a budget that each one of these factors has. A client currently does not have a system to collect, manage and maintain all of the data on contributing factors which cause a submitted budget to be reliable, to manage and control the budget or which would allow the client to adequately determine if the proposed budget by a law firm or attorney for a lawsuit or regulatory matter is reasonable. This forces a client to make a guess based on inaccurate data and inconsistent metrics as to the reasonableness or accuracy of a budget which the client, in the end, has no control over.

Additionally, because a client does not have a uniform manner or standardized language for phases, processes and tasks in litigation, the client has no method other than previous experience based on historical invoicing that contains billing inefficiencies, different codes assigned to the same task, unnecessary rework of the same tasks, completion of tasks which provide no benefit to the client, etc., to determine if a law firm's or attorney's proposed budget is either accurate or reasonable. Further, the client has no way to compare and contrast the rates and budgets of different attorneys and law firms or even attorneys within the same law firm. Clients have no way to compare the effect on a proposed budget that having different attorneys within the same firm handle different aspects of a lawsuit or regulatory matter.

An attorney's or law firm's fee agreement is typically completed on a fixed fee basis, contingency fee basis, blended rate basis or hourly fee basis. In each of these fee arrangements, the client will receive a monthly invoice outlining the work performed by the attorney and the amount of time that the attorney spent performing the work. The narrative of work performed by the attorney can vary significantly from attorney to attorney and firm to firm based on how that individual attorney describes the work they completed. For example, an attorney at one firm could use the American Bar Association's uniform descriptions with additional narrative language while another attorney could use their own vague language to give the client a general idea of the work performed. Some of the narrative language could even include attorney-client privileged communications regarding the work performed or strategy discussed between the client and the attorney handling the lawsuit or regulatory matter and subject to inadvertent disclosure should there be a dispute over the reasonableness of time spent and attorney fees incurred.

Specifically, a fixed fee basis, also referred to as a flat fee basis, is where the attorney or law firm performs a certain phase of litigation or takes on a lawsuit for a pre-set fixed fee. An attorney's hours and work performed under this fee arrangement are still tracked for purposes of reporting for the attorney's law firm and may or may not be reported to the client, on a monthly basis. Should the attorney spend more time than allotted under the fixed fee basis, then the law firm and attorney would not receive compensation for the hours which were spent in excess of the fixed flat fee. If this happens, an attorney may attempt to renegotiate the previously agreed upon fee agreement and use the “shadow bills” which may or may not have been provided to the client to negotiate a new fee agreement. Furthermore, if an attorney exceeds the amount of time theoretically allotted, then work product of the attorney may suffer as the attorney rushes to complete a specific task. Should the attorney spend less time than allotted under the fixed fee basis, then the client will have overpaid for the legal services of the attorney or law firm.

In a contingency fee arrangement, the attorney or law firm receives, as compensation, a percentage of the amount recovered on behalf of the client. On a contingency fee arrangement, a narrative of the work performed on behalf of the client and the amount of time spent performing the work may or may not be reported to the client for review, typically on a monthly basis. Like fixed fee arrangements, a contingency fee arrangement also has specific draw backs to both the attorney/law firm and client. For example, the attorney or law firm may not be able to recover enough in the lawsuit so as to adequately cover the attorney fees for the matter had the matter been billed on an hourly basis resulting in poorly or hastily performed tasks or the law firm may unduly pressure a client into continuing litigation in the hopes of receiving a higher recovery on behalf of the client so that the attorney or law firm recovers a greater amount due to their percentage of recovery. Worse yet, if the attorney or law firm determines that the amount of recovery will be limited, the quality of work product may decline in turn. Conversely, if an abnormally high reward is achieved on behalf of the client, then the attorney or law firm will receive an un-proportionally high fee to the amount of work performed for the client or the complexity of the legal matter.

The hourly fee basis for compensation is the most common type of compensation arrangement. These hourly fee arrangements also generally form the client's historical knowledge of how much a particular legal matter should cost. Generally, an individual attorney will record a narrative of the work performed on behalf of the client and the time spent performing such work. After a partner reviews the narrative of work performed and time spent performing the work, this narrative is then compiled into a summary for the client. If the partner determines that there are issues with the attorney's narrative or time spent performing a certain task, then the partner will communicate with the attorney who performed the work for further clarification. If multiple attorneys are working on the same legal matter, then the work performed by the individual attorney will be billed at that attorney's hourly rate. After review and approval by a partner, the invoice is typically sent to an accounting department within the law firm for a further review for conformity with the client's individual billing guidelines and for verification within the law firm's own billing system. This process results in countless lost hours by the attorneys completing a descriptive, variable narrative, as well as by the partner and accounting department within the law firm reviewing the attorney's descriptive, variable narrative.

The blended fee rate for compensation is when all the rates for all of the attorneys who will be working on a particular legal matter are averaged or “blended”. An attorney's hours and work performed are still tracked under this fee arrangement for purposes of reporting for the attorney's law firm and reported to the client on a monthly basis. Like with the hourly fee basis for compensation, a partner must review the work performed and narrative and then pass the invoice to the accounting department within the law firm for further review. The blended fee rate presents the results in the same countless hours lost by attorneys as the hourly fee basis.

If the law firm's billing department finds an issue with the invoice, then the accounting department must contact the attorney who performed the work or the partner for correction. Once the invoice is corrected, the invoice passes through the accounting department a second time. The client is then invoiced, typically on a monthly basis, for the amount of time spent by an attorney performing the described work over the past month at the attorney's hourly rate.

Once a client receives the monthly invoice, the invoice is typically passed to corporate counsel or a corporate case manager, if available, for review and approval after the client's accounting department scans the invoice into the client's system. Corporate counsel or a corporate case manager must set aside time specifically to review, critique, approve or disapprove the invoice for payment. Often, corporate counsel or a case manager will employ the use of e-billing systems to catch descriptions which may be batch billing or bulk billing, large individual time blocks which do not meet client billing guidelines via filters. Unfortunately, sometimes these filters will inappropriately flag time entries as batch billing or large time blocks as invalid. For example, a deposition of an expert witness may take more than eight hours and this time entry could be flagged as inappropriate billing by the client's e-billing system. If the invoice is disapproved, then the attorney or law firm may have the option to submit an appeal of the denial by making clarifications or providing additional information to the client.

These fee arrangements and especially the hourly fee basis, requires considerable time investments from both the law firm and the client. Difficult billing situations—approvals and/or disapprovals—can result in strains on the attorney-client relationship and poor communication in the future. The flow of invoice presentment and client approval results in significant delays in payment to the attorney or law firm for services previously rendered.

Previous billing methods and fee arrangements can also result in a multitude of additional issues. For example, the attorney may be double billing for work previously performed or performed by another attorney within the same law firm unbeknownst to the attorney. The client will inadvertently pay this double billing, unless the client completes a detailed and time intensive review system for invoices to confirm that work performed has not already been performed and paid for previously on another invoice. The client may be forced to decipher and attempt to lump together for comparison and analysis the work narrative presented by two separate attorneys or separate law firms and the client will be forced to view vague and uninformative attorney narratives of work performed due to varying descriptions of work

Furthermore, previous billing methods do not allow for easy adjustment of a budget to take into account different factors—such as the assigned judge, opposing counsel, the lead attorney's lawsuit or regulatory matter management style, different attorney's hourly billing rates, different aspects between different jurisdictions, and complexity of the legal matter assigned—different strategy tactics—such as the filing of a motion for dismissal or certain discovery motions—or re-assigning the lawsuit or regulatory matter to another attorney or law firm for management. If a client or attorney wanted to include potential impacts of different factors or strategy on the budget, the client and attorney would be forced to proceed in the time intensive process of modifying the budget separately for each factor revision or strategy update. This results in additional time spent by both the client and the attorney on budgeting issues.

A client, individual attorney or law firm must have access to a litigation or regulatory matter legal task and cost control management system which allows the client, through their corporate counsel or litigation case manager, to fully customize and control the budget and fees associated with the a lawsuit or regulatory matter, modify the budget based on changes in strategy or the factors having an impact on the reasonableness and accuracy of a budget, and capture completed tasks in real-time as the attorney completes a budgeted item. A legal task value management system would allow for the creation of a budget based on specific standardized tasks utilizing process management methodologies not currently available to the client in various legal practice areas. A client is able to apply the legal task value management system not only to regulatory matters, but also a variety of legal areas, such as: banking and financial services, bankruptcy, restructuring and creditor's rights, construction, corporate law, corporate finance, employee benefits, environmental law, energy and sustainability, estate planning administration and litigation, family and matrimonial law, among others. While the analysis herein is mostly applicable to general litigation or regulatory matters, this is not meant to be a limitation of the claimed invention.

A legal task value management system would allow a client to create and manage the factors (for example, jurisdiction, the assigned judge, opposing counsel, etc.) which affect the proposed budget and allow the client to account for and adequately manage those factors during the budget approval process with the attorney or law firm prior to commencing work on the lawsuit or regulatory matter. A legal task value management system with standardized language for the various phases, processes and tasks associated with litigation or regulatory matters eases the budget negotiation process as both the client and the attorney will be using the same standardized common language in the negotiation process for budget approval.

A legal task value management system would allow a client to approve an “upper limit” or “cap” of fees for tasks performed in a legal or regulatory matter. This allows a client to adequately calculate the potential impact of the lawsuit or regulatory matter on the client and provide a more accurate risk exposure assessment. If a deviation from the budget was required in the litigation or regulatory matter, the attorney or law firm could easily submit for review, revision, denial or approval from the previously approved budget by the client. A legal task value management system would ensure that the client always had control of the budget for a lawsuit or regulatory matter. Applicant's system enables a client to apply alternative fee arrangements at the individual task level. This allows the client assign specific values to a task. For example, the client may wish to compensate the attorney conducting a deposition at an hourly rate while paying a value fee for the performance of early case assessment where a more experienced attorney can perform a more accurate and comprehensive assessment in a shorter period that a less experienced attorney. The client would also be able to limit compensation when the attorney's work-product is based on a previously formatted “templates” such as a motion to compel.

A legal task value management system would also allow a client, through their corporate counsel or litigation case manager, to eliminate double billing, duplicate completed tasks or unnecessarily performed work via the use of process maps which allow for task value pricing at the outset of the lawsuit or regulatory matter to establish a budget. A legal task value management system allows a client to easily confirm what services have already been rendered in real time.

A legal task value management system which dynamically creates an invoice from a previously agreed upon budget removes the independent attorney narrative and review process as the client has already agreed to the proposed budget with a standardized task description and the invoice, created from the approved budget, can be submitted for payment without further review by a partner, accounting department or other review process as set up by the law firm. The client, attorney and law firm would save invaluable time and no longer be forced to review monthly invoices for completeness, accuracy or conformity with the client's individual billing guidelines.

An embodiment of the legal task value management system would allow for the budget to be modified by the law firm and the client, via their corporate counsel or case manager, if it is determined that a modification to the budget is necessary. For example, if a client and the law firm determined that a different level of law firm attorney could complete a desired level of tasks, the legal task value management system would allow for the modification of all individual tasks to modify the budget in real time. This allows real time communication between the client and attorney regarding the budget and increased control for the client of the budget.

An embodiment of the legal task value management system would allow for deviations from the budget to be made by the law firm and approved, revised or denied by the client, via their corporate counsel or case manager, in real time, via the exception request process. This allows for real-time communication between the client and attorney regarding the status and the total cost for the law firm to handle the lawsuit or regulatory matter. Furthermore, this allows for the real time revision of the budget due to the exception request process.

An embodiment of the legal task value management system would allow for the creation of an hourly interpretation of the completed tasks within the system for use at the outside counsel's law firm for the law firm's internal use.

An embodiment of the legal task value management system would allow for real time invoice creation at any time from the approved budget relative to the different tasks to be completed by the attorney because costs and attorney fees are captured at the time that the task is completed by the attorney. A client would no longer be forced to wait for the end of the month to review the outstanding invoice for a legal or regulatory matter as the client would be notified in real time once outside counsel submitted the invoice to the client.

An embodiment of the legal task value management system would allow for variations of the budget based on different factors in order to assist in the creation of a reliable and accurate budget. Another embodiment of the legal task value management system is for the collection and analysis of the effect which different factors have on the effect on a lawsuit or regulatory matter.

### BRIEF DESCRIPTION OF THE DRAWINGS

These and other features and advantages of the present invention will become more readily appreciated as the same becomes better understood by reference to the following detailed description when considered in connection with the accompanying drawings, wherein:

FIG. 1 is a flow chart illustrating the basic areas of modules of the legal task value management system;

FIG. 2 illustrates a process map for the steps involved in responding to a complaint;

FIG. 3 the second part of the process map for responding to a complaint;

FIG. 4 illustrates a process map for preparing and filing a cross complaint;

FIG. 5 is the second part of the process map for filing a cross complaint;

FIG. 6 illustrates the process map for preparing an affidavit;

FIG. 7 is the second part of the process map for preparing an affidavit;

FIG. 8 illustrates an output from the computer screen illustrating the default values tab selected:

FIG. 9 illustrates a screen output for the alternative fee arrangements possible;

FIG. 10 illustrates a flow chart that shows the steps outside and/or corporate counsel goes through when generating a new case budget;

FIG. 11 is continuation of the steps outside and/or corporate counsel goes through when developing a new case budget;

FIG. 12A is a screen printout from the legal task value management system illustrating a budget and litigation worksheet prepared for submission to outside counsel;

FIG. 12B is a continued screen printout from the legal task value management system illustrating a budget based on phases and litigation worksheet prepared for submission to outside counsel;

FIG. 13 illustrates a screen output from the legal task value management system from corporate counsel's perspective and provides an example of cases in the system;

FIG. 14 illustrates a screen output for the present invention from outside counsel's perspective and depicting a current case budget status by phases of the matter;

FIG. 15 illustrates a work flow diagram of the invoicing/billing system of the present invention;

FIG. 16 illustrates a work flow diagram from outside counsel's perspective of the billing/invoicing process;

FIG. 17 is a work flow diagram from the outside counsel's perspective, of the expense invoicing process;

FIG. 18 illustrates a work flow diagram of the exception request process from the perspective of outside counsel;

FIG. 19 illustrates the exception request process from the perspective of outside and/or corporate counsel;

FIG. 20 illustrates a screen output from the present invention from outside and/or corporate counsel's perspective, showing the exception request;

FIG. 21 illustrates one type of statistical report that the present invention can create as it relates to the original budget as negotiated versus amount invoiced to date and age of the matter;

FIG. 22 illustrates one type of statistical report that the present invention can create as it relates to a comparison of different outside counsel's billing for a specific phase of a legal matter;

FIG. 23 illustrates one type of statistical report that the present invention can create as it relates to a comparison of different outside counsel's billing for a specific process in a legal matter;

FIG. 24 illustrates one type of statistical report that the present invention can create as it relates to a comparison of different outside counsel's billing for a particular task group in a legal matter; and

FIG. 25 illustrates the present invention being used via the cloud.

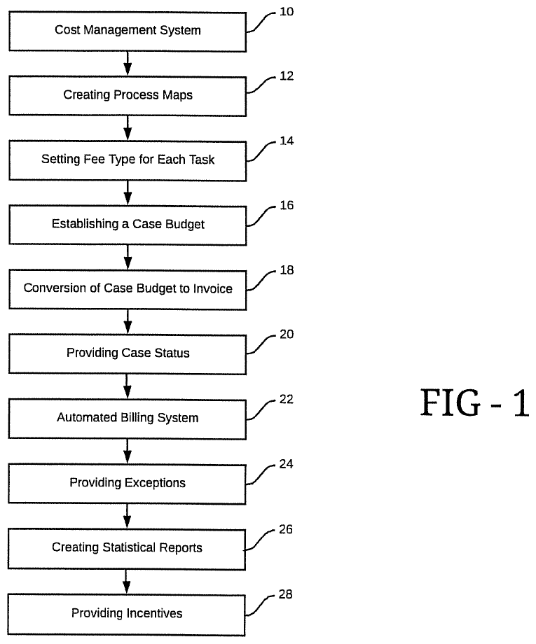

### DETAILED DESCRIPTION OF THE PREFERRED EMBODIMENT

The Legal Task Value Management System 10 uses a computer such as a pc, mac, tablet, smart phone, smart watch or the like and allows corporate counsel to communicate through the internet, cloud, etc., with outside counsel. The Legal Task Value Management System 10 operated using preferable modules that are interconnected for processing various aspects of the system. The System 10 includes a creating process maps module 12, setting the fee type module 14, a project budget module 16, conversion of a project budget to invoice module 18, a project status module 20, automated billing invoicing system module 22, an exceptions module 24, a statistical reporting module 26, and an incentives module 28. These modules collectively define the Legal Task Value Management System which allows corporate counsel to effectively manage the legal process and its associated costs, when the work is being done. It will be appreciated that the number of modules can vary, without departing from the present invention.

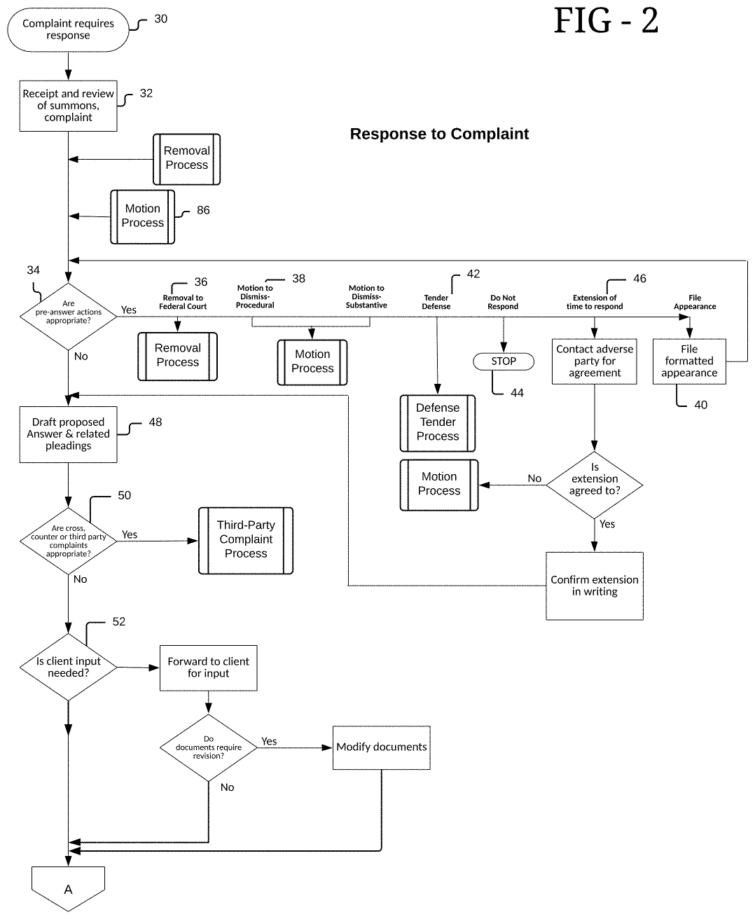

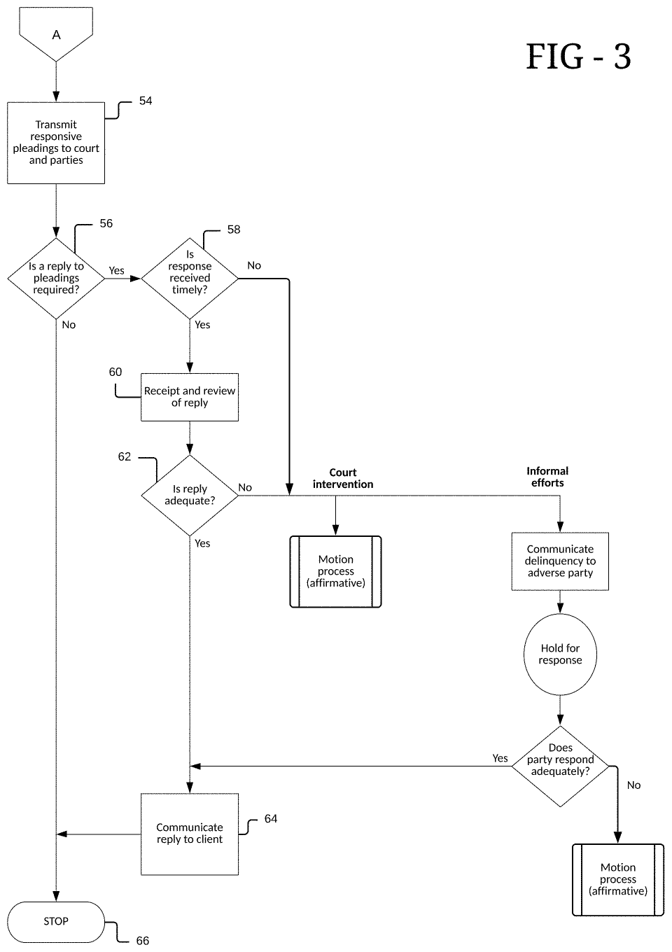

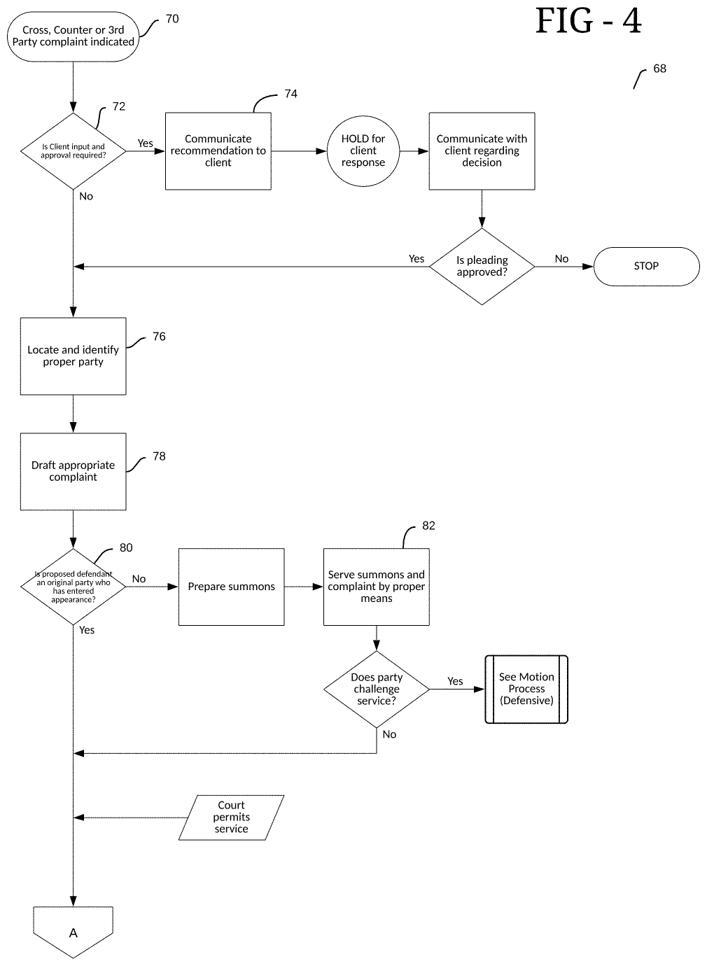

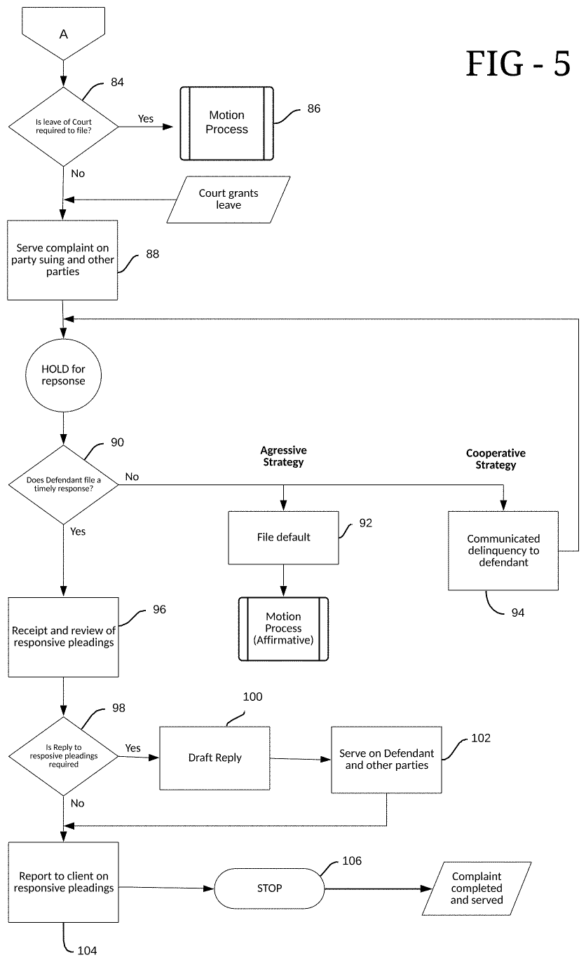

For discussion purposes, the process of managing legal costs will be described in detail as it relates to the litigation process rather than the regulatory process. It will be appreciated that the Legal Task Value Management System 10 can be used in all practice areas, including, but not limited to: regulatory, banking and financial services, bankruptcy, restructuring, creditors' rights, construction, corporate, employee benefits, energy, environmental, estate planning, employment, sports, media merger, municipal, family, educational, securities, patent, taxation, and class action. The process maps module 12 includes over 100 different maps of the legal process. A few of these process maps are shown in FIGS. 2-7. The process maps represent the steps involved in a particular task, for example responding to a complaint as shown in FIGS. 2 and 3, or preparing a cross-complaint as showing FIGS. 4 and 5. The present Legal Task Management System 10 has in it a map of every task of the litigation or regulatory process and these process maps are placed in a database where they can be called upon at the outset of the case by corporate counsel. Each litigation task has a value assigned to it so that a budget can be created. The present invention includes process maps that are available to corporate counsel which are utilized for budgeting and cost management purposes in a litigation matter. For example, the following process maps could be present in the System 10:

(Commencement of Actions/Pleadings).

1. Responsive Pleadings and Third Party Practice.

2. Federal Court Removal Process.

3. Cross, Counter and/or Third Party Complaint.

(Motion Practice).

4. Motion Practice (Affirmative).

5. Motion Practice (Defensive).

(Discovery Directed to Other Parties).

6. Interrogatories (Affirmative).

7. Depositions by Oral Testimony.

8. Depositions by Written Questions.

9. Requests for Production.

10. Requests to Admit.

11. Requests for Examination of Third Party or Premises

12. Compelling Production of Documents and Things from Non-Parties.

13. Meeting with Witness Who is Not an Expert or the Client.

(Discovery Directed to Client).

14. Interrogatories.

15. Depositions by Oral testimony.

16. Depositions on Written Questions.

17. Request for Production of Documents and Things.

18. Requests to Admit.

(Investigation).

19. Research Technical and Background Information.

20. Meeting with Client and Witnesses.

21. On-Site Inspection Off Premises.

(Other Activities).

22. Offer of Judgment (Affirmative).

23. Offer of Judgment (Defensive).

24. Drafting Affidavit.

25. Evidentiary Hearing.

26. Pretrial and Settlement Conferences.

27. Expert Witnesses.

28. Witness Preparation.

(Resolution Efforts).

29. Mediation/Facilitation Efforts.

The Legal Task Value Management System 10 is capable of utilizing other process maps that could be added to the System pursuant to corporate counsel specifications or requirements for the legal matter. These process maps in the System 10 can be modified by corporate counsel in order to customize the expected process for a particular piece of litigation or individual jurisdiction. Thus, the System is flexible in that it can be modified in order to manage the cost of any type of litigation, regulatory matter, corporate counsel or as new types or processes for legal matters are developed.

FIG. 2 depicts a process map 12 for the steps involved with, outside counsel responding to a Complaint 30. The first step is to receive and review 32 the complaint and ascertain whether pre-answer actions 34 are appropriate. If action is necessary, then actions such as removal to Federal Court 36, filing a motion to dismiss 38, can take place. Counsel can also file an appearance 40, or, if insurance or a third party may be responsible, the defendant could tender a defense 42 at which time future would stop 44 if the defense is accepted. A party may also obtain an extension of time 46 in order to proceed onward with the case.

FIG. 3 illustrates additional steps for responding to the complaint which includes transmitting 54 the responsive pleadings to the court. Once that is done a determination 56 must be made as to whether a reply to the pleading is required, and, if so, a decision 58 is made as to whether a response is timely received. If it has been timely received, then it is reviewed 60 and a determination 62 is made as to whether the reply is adequate. If it is adequate, then it is communicated 64 to the client. Thereafter, the process for responding to the complaint is stopped 66. No further action is taken on this process map. Thereafter, the billing attorney in charge of this customer can go to the billing module 22. Once the billing attorney clicks to send the invoice to corporate counsel, the System 10 takes the budget for the completed task or tasks which was pre-approved and negotiated between corporate counsel and the billing attorney and automatically creates an invoice to send to corporate counsel for payment. The creation of an invoice is based on the budget which is prepared by the System 10 based on collected data points and different budget factors. It will be appreciated that the point and click process can be done at any pre-described task segment within each given process.

FIGS. 4 and 5 illustrate a process map 68 for preparing a cross-complaint, counter-complaint or third-party complaint 70. First a decision 72 is made as to whether client input is necessary and if so, the client is informed 74. If client input is not required, then it is necessary to locate and identify the proper party 76, draft the appropriate complaint 78 and then a decision 80 must be made as to whether the proposed defendant is an original party. If not, then a summons must be made and served 82. If the proposed defendant is an original party, then a decision 84 as to whether leave of court is made, and, if so, then the motion practice module 86 is selected. If leave of court is not required, then the complaint is served 88 and the parties wait to determine whether defendant files a timely response 90. If the defendant does not file a timely response, then a default is filed 92 or communication 94 is made with the opponent. However, if the answer is received 96, then a decision 98 is made as to whether any responsive pleadings must be drafted 100 and served 102 on the defendant or the other parties. However, if no responsive pleading is required, then the status is reported 104 to the client where this process is then completed and stopped 106. This summarizes the individual tasks that are encountered when preparing, filing and processing a cross-complaint. Once this work is done, the billing system module 22 can be accessed by the billing attorney, and an invoice can automatically be generated and sent electronically to corporate counsel, to his accounting department, through the internet or some other electronic means. The appropriate personnel can bill completed segments as the work is finished without waiting for the entire responsive pleading practice being completed.

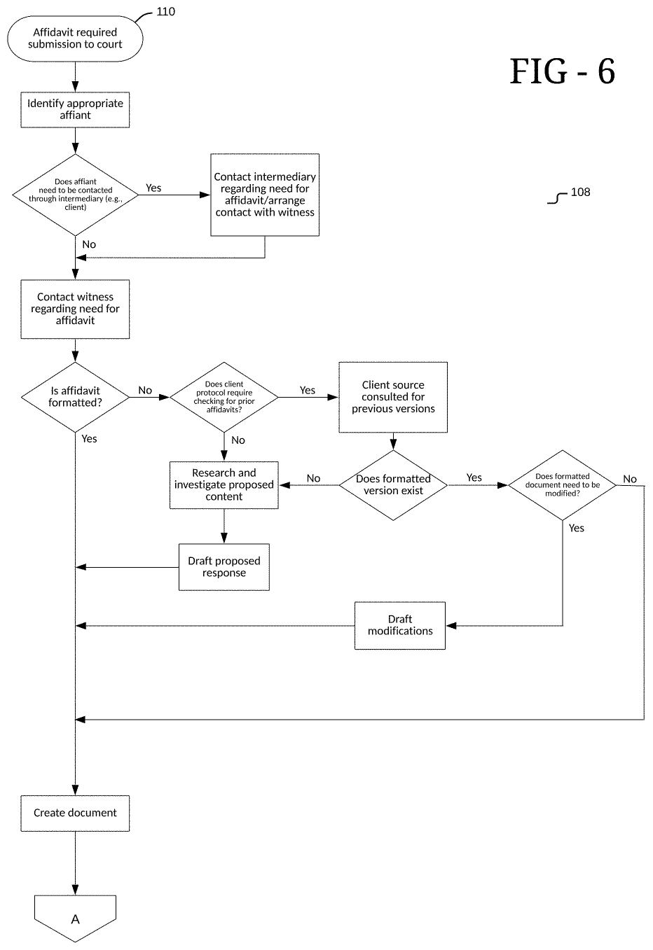

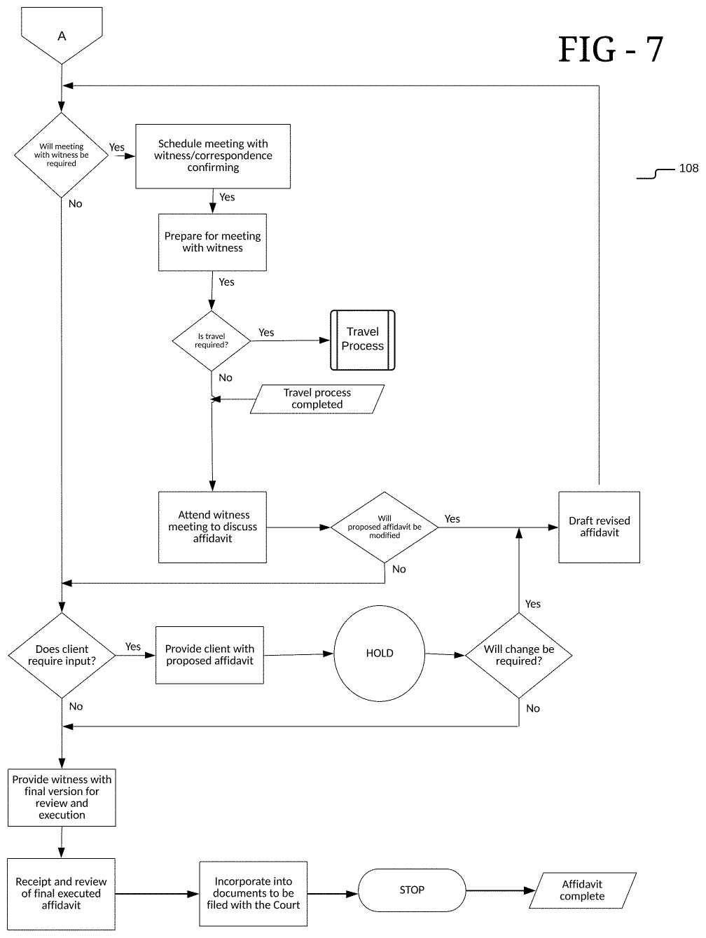

FIGS. 6 and 7 illustrate the process map 108 for creating an affidavit 110. The individual tasks are set out in the process maps depicted in FIGS. 6 and 7. Each individual action task has a pricing value with a range associated with it. During the budgeting process, these values are input or activated by corporate counsel in order to generate a proposed budget. It will be appreciated that similar types of process maps are created for each of the other above-mentioned litigation processes. If corporate counsel were to add additional process maps as discussed above, corporate counsel would either input the pricing value or activate the pricing value for each individual action task during the initial budgeting process. The process maps illustrated in FIGS. 2-7 are merely representative of the process maps utilized by the System 10 which would be of similar logic as the one disclosed herein, but specifically tailored for their particular litigation process.

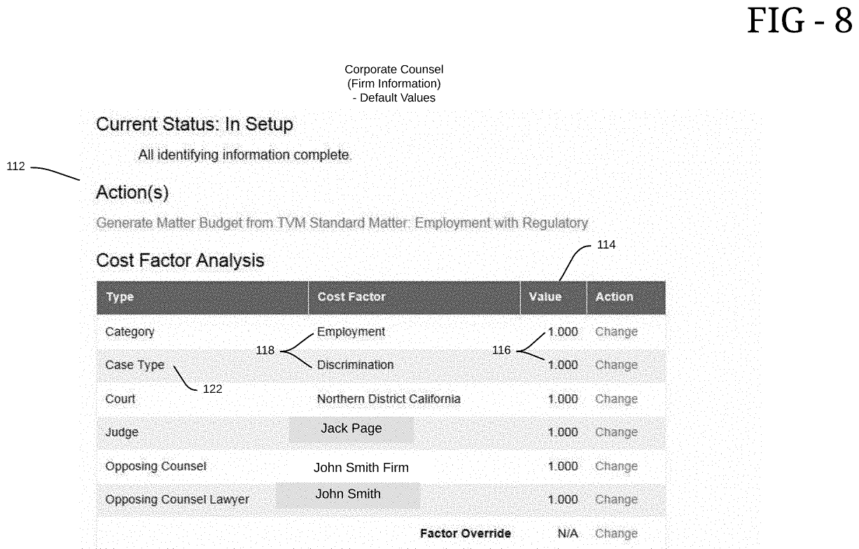

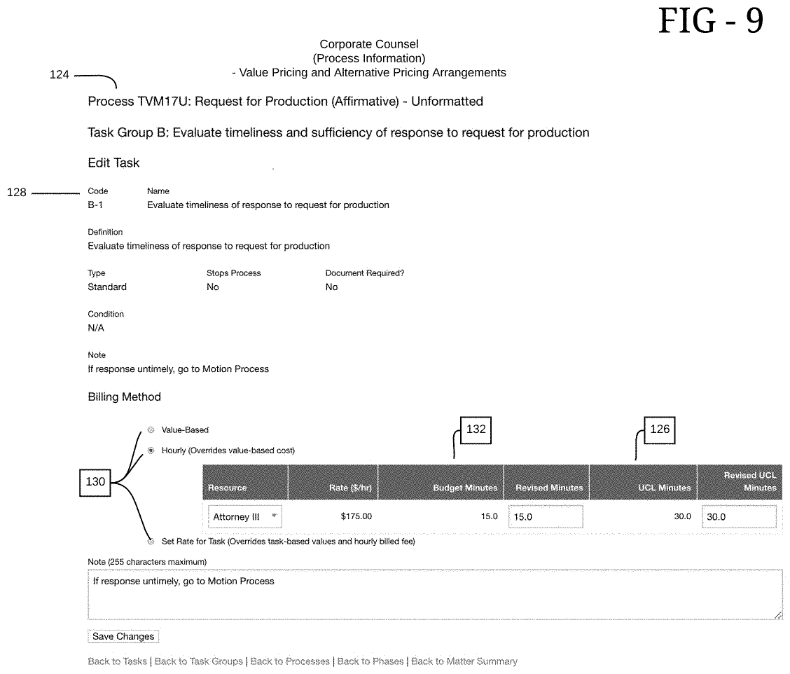

FIGS. 8 and 9 depict screens from the setting pricing variables and defaults module 14 of the Legal Task Value Management System 10. FIG. 8 shows the baseline of the cost factor values in the System 10. The cost factor values can have an affect on multiple tasks. For example, the System 10 may be able to recognize that a particular opposing counsel may require excessive motions. This will affect the cost of multiple tasks and the overall budget. These baseline values can be changed by adjusting the default values, which is done by going to screen 112 of FIG. 8. The default values shown in FIG. 8 can be preset for a particular matter. A formula can be used to compute the default values once the matter is setup in the System 10. It will be appreciated that these factors also allow for additional adjustment of the cost factor values in order to generate an accurate and precise budget. The System 10 identifies individual tasks that each cost factor value impacts and applies the necessary cost factor value to only those tasks. For example, if the opposing counsel cost factor value is increased by one-half due to additional motions, then all of the tasks that are affected are increased by a cost value factor of one-half.

The Legal Task Value Management System 10 is divided into sections which only corporate counsel can view and windows which only outside counsel can view. FIGS. 8 and 9 illustrate screen outputs from the pricing variable/defaults module 14 that corporate counsel will see when he or she enters the case information into the System. With respect to FIG. 8, corporate counsel will see a screen 112 with a general tab and a default values tab. When the default value tab 114 is selected, cost factor values 116 are already preset, for example, type of case, court, judge and other categories 118. As law firms are added to the System 10, information necessary to complete the categories 118 is updated by the System. The System 10 will show the default values 114 which are generated by the System 10 based on real-time and historic data compiled and created by the System 10. These default values 114 can be changed by corporate counsel if the defaults are not acceptable for a particular legal matter or if corporate counsel is aware that a particular cost factor 118 has changed. For example, a change in a court rule may cause a change in the default values 114—either by lowering or increasing the default values 114. The purpose of the categories 118 is to take into consideration standard features that are inherent with the type of case 122 and venue. The default values 114 are factored in when creating the case budget. The default values 114 also assist corporate counsel in creating an accurate budget which will factor in intricacies and differences in the particular law firms, judges, courts, etc. which may cause an average budget to be higher or lower. These types of parameters assist corporate counsel in standardizing the System 10 and to maintain continuity in the budgeting process.

The court location category 118 takes into consideration the location where the case is pending. For example, a higher the value may indicate that the matter is pending before a court which has additional local rules and procedures unique to that court. The type of case category 122 takes into consideration the complexity of the case and, for example, places a higher value on intellectual property cases and a lower value on cases such as workers' compensation. The other categories, such as opposing counsel, opposing counsel lawyer, judge, and case type, provide additional factors for corporate counsel to take into consideration when creating a budget and assist corporate counsel in the creation of the most effective and accurate budget.

FIG. 9 illustrates a screen shot 124 with different pricing structures 130 (i.e. contingent fee, hourly fee, value based fee arrangement, blended fee, set rate—which includes adjustments of the default values 114, etc.) for each particular task with upper and lower cost controls 126. It will be appreciated that the upper control limits 126 include not only the longer allotted time in an hourly fee arrangement, but also optional and alternative processes and task groups that may be performed. One of the aspects of the present invention is it allows corporate counsel to specifically price each individual task 128 in the process map and allows for the different pricing structures. It will be appreciated that each task can be assigned different pricing structures by corporate counsel rather than limiting corporate counsel to one fee arrangement for the entire matter. Here, for the hourly fee, an upper control limit of 30.0 minutes 126 is allotted for a task with a budgeted amount of 15.0 minutes 132. If outside counsel goes above the upper control limit 126 for the amount of time for a particular hourly based task, they would have to submit an exception request or accept the upper control limit previously set by corporate counsel. Thus, the System 10 is flexible in its pricing structure. The upper control limit 126 is provided for each action step that is set out in the process map and collectively is accumulated with all other maps within the System 10 in order to generate a proposed budget. Corporate counsel may go to the screen, change the values that are in the upper control limit 126 so as to adjust the value for a given task 128. Corporate counsel sets these formulas or variables for each of the tasks in the process maps prior to the case budget being submitted to outside counsel. It will be appreciated that these formulas and variables could be baseline values which could take into account task description, level of expertise, normal hourly rates and time required to complete a certain task and the value of the task. Modifying variables allows corporate counsel the flexibility to give ranges of acceptable values for each task. It will be appreciated that at the discretion of corporate counsel, no range can be assigned, but instead, a fixed value or factored value fee, etc. for each task can be input.

Each task can have a dollar range associated with it to provide upper and lower control limits for a particular event. As long as outside counsel stays within these control limits, the System 10 can automatically approve any invoice regarding performance of such task. Alternatively, corporate counsel could require that all invoices are to be manually reviewed prior to approval. Also, corporate counsel can track when outside counsel performs within the predetermined range, so as to compare a particular law firm to other firms. This type of unique and standardized data is created by the statistical reports module 26.

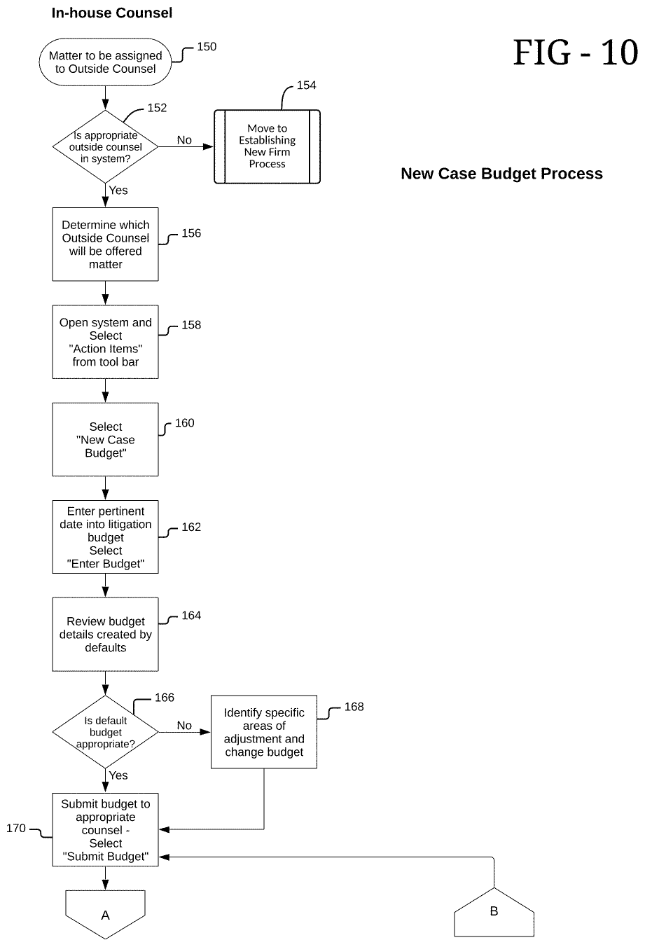

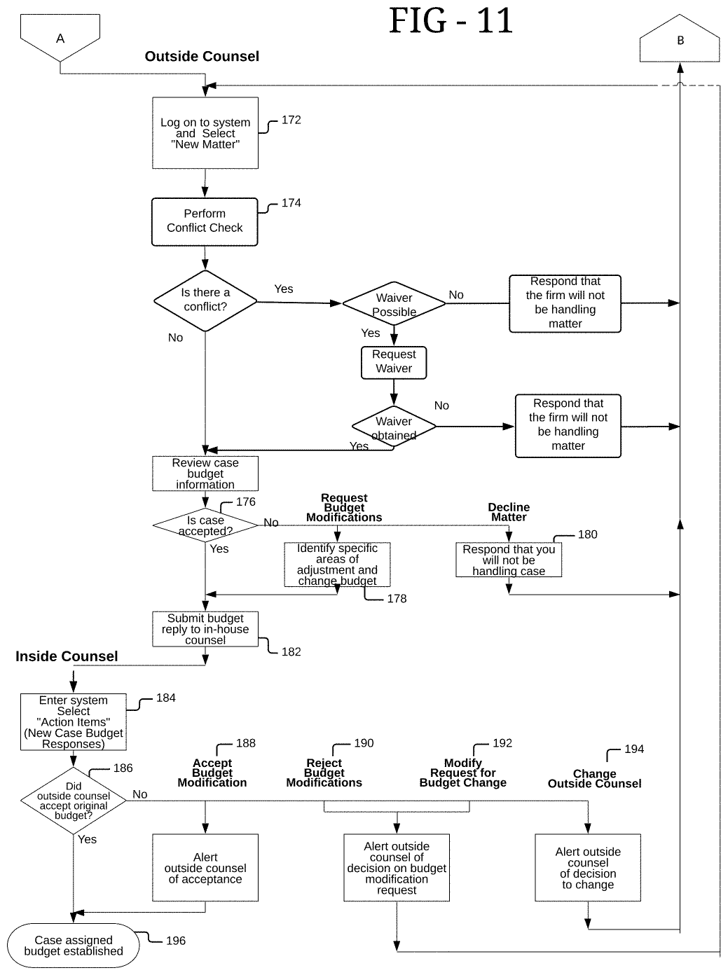

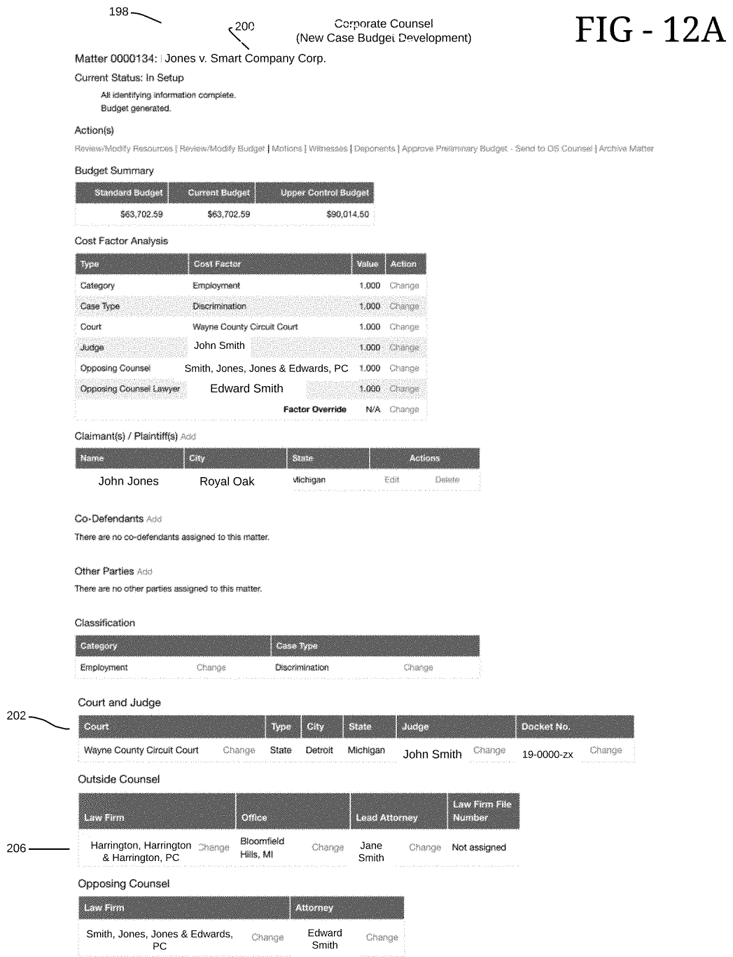

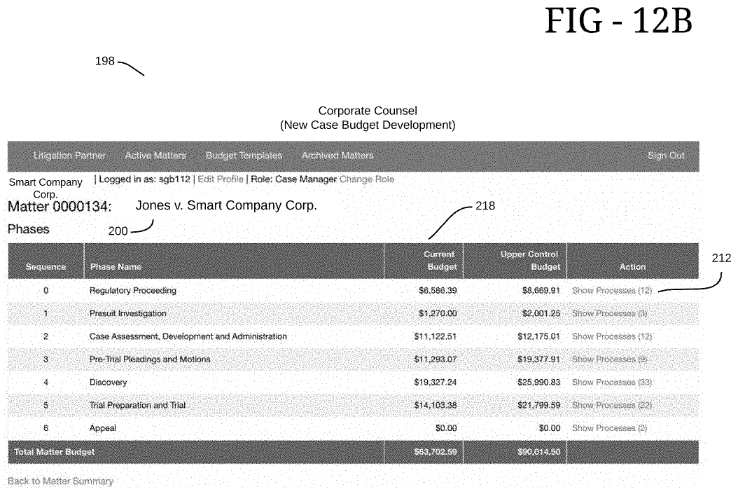

FIGS. 10 and 11 illustrate the steps outside and/or corporate counsel goes through in order to establish a case budget 16. FIGS. 12 and 13 illustrate a budget litigation worksheet screen that corporate and outside counsel use when creating a new case budget. It will be appreciated that this is merely an example representative of the various screens that either counsel may see.

FIG. 10 illustrates the steps that corporate counsel goes through in order to set up a new case budget. First, corporate counsel (or “in-house counsel”) ascertains whether the matter is to be sent to outside counsel 150. A decision 152 is made as to whether outside counsel is currently in the System 10 and, if not, it must be placed into the system 154. If they are in the System 10, then it must be determined 156 which outside counsel to refer the matter to. Once that is done, outside counsel begins the process by starting the Legal Task Value Management System and then clicking on the action items 158 toolbar and selecting a new case budget window 160. Once the window is open, corporate counsel enters pertinent data into the system and then hits the enter budget button 162.

Next, corporate counsel reviews the budget details that are created by the defaults 164 and makes a decision 166 as to whether the budget is appropriate and if it is not, then the budget is changed 168. However, if the default budget is appropriate, then the budget is submitted 170 to outside counsel.

FIG. 11, illustrates the steps associated with outside counsel reviewing the proposed budget. This is accomplished with outside counsel logging on 172 to the system and selecting the new matter button. Outside counsel now reviews 174 the case budget information and ascertains 176 whether it is acceptable. If it is not acceptable, then modifications 178 via a change request by outside counsel to modify the budget as proposed by corporate counsel or the matter can be declined 180 by outside counsel. However, if the case is accepted, then the budget, including any proposed modifications, is submitted back to corporate counsel 182.

Corporate counsel now goes to the action items tab and clicks on new case budget responses 184. A decision 186 is then made as to whether outside counsel accepts the original budget, and if not, corporate counsel may consider alternative actions such as accepting the modified budget 188, or rejecting the budget modifications 190, or modify the request for budget change 192 or to change outside counsel 194. Alternatively, if the original budget is accepted, then the case is assigned 196 to the outside counsel and a budget is established.

The above steps set forth in FIGS. 10 and 11 show the entire process of establishing a new case budget. This becomes the roadmap for all future work that is done on this particular case by outside counsel. The established and agreed upon budget also forms the basis for the invoice created by the System 10 and the outside counsel still has the ability to submit for an exception 24 to the previously established budget should circumstances change.

FIG. 12A illustrates an example screen 198 the corporate counsel sees at the step of submitting the budget 170. The budget worksheet identifies in fields the particular name of the plaintiff 200, the location of the lawsuit 202, and the name of the outside counsel 206 that has been identified in step 156 as the proposed outside counsel. It will be appreciated that this screen can have other categories other than those set forth herein and as required or requested by corporate counsel allowing for additional customization for each corporate counsel.

FIG. 12B illustrates a continued screen 198 the corporate counsel sees if the type of case has been done before, and the pricing is in the System 10, then corporate counsel may use the same defaults and values as previously used to generate a budget. After the budget is generated, corporate counsel then may tailor fit the default budget for a particular type of legal matter. To modify the default budget, corporate counsel, for example, may review the individual review processes 212 within a phase that he or she wants to modify and a screen pops up. The screen, for example, allows for additional tasks to be added which in turn allows the default budget to generate a new budget specifically designed for a particular case.

Columns are provided that open the review processes 212 which provide default descriptions of the work processes in each particular phase to be selected by outside counsel. It will be appreciated that the System 10 allows for this to be repeated down to the individual task level. Fees are added to create the proposed budget 218 by corporate counsel. The budget is transmitted to outside counsel for review.

The case status module 20 of the System 10 provides various screens 238 for providing information to corporate counsel. FIG. 13 illustrates a screen 238 that corporate counsel reviews in order to check the status of an existing case within the System 10. From the screen 238, corporate counsel can select specific cases in order to obtain real time information on any particular case the company is monitoring, as long as the data for that case has been put into the System 10. The cases illustrated in FIG. 13 are merely exemplary. It will be appreciated that the case status module 20 can be modified to provide relevant information at a glance to corporate counsel, including, but not limited to: the file number, matter name, negotiated budget, current budget, current upper control limit of the budget, the amount invoiced to date, matter status, etc. Corporate counsel can also see a comparison of the amount budgeted and the amount remaining in the budget.

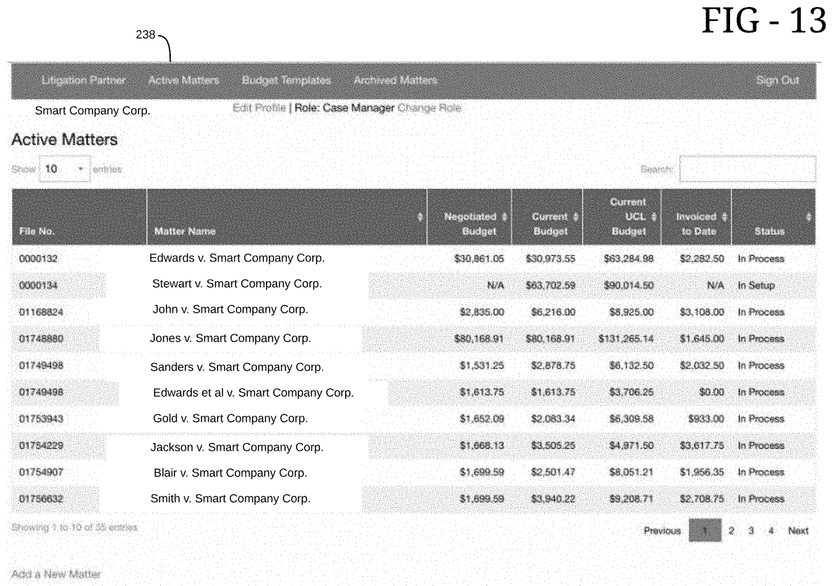

FIG. 14 illustrates a screen output 240 that outside counsel sees which shows the budgeted quantity for current phases available for completion by the outside counsel. After reviewing screen output 240, outside counsel may can request a change to the quantity which would be approved by corporate counsel. If corporate counsel approves the change request, then the budget would be modified down to the individual task level for all affected tasks within that process.

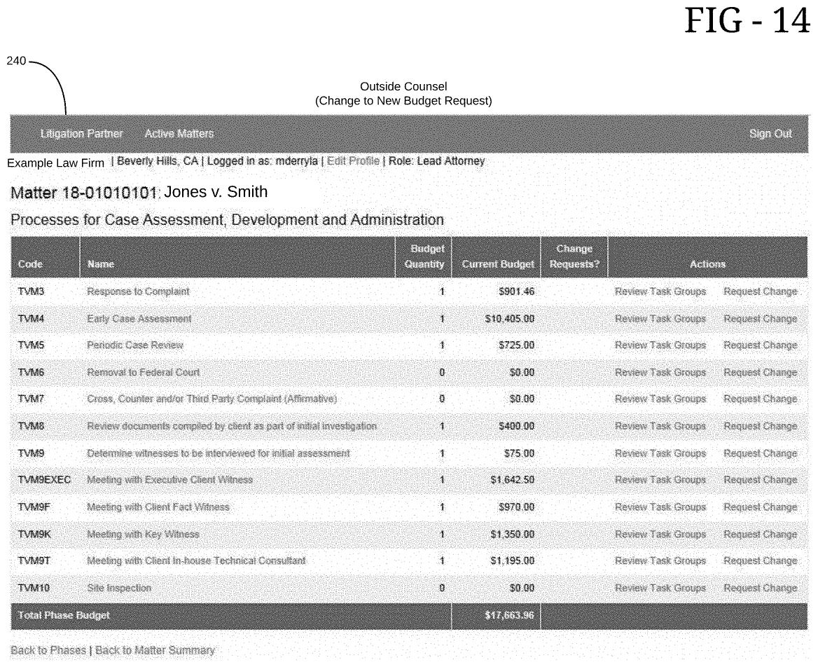

FIG. 15 represents the billing system module 22 which minimizes steps outside counsel must take in order to get paid. The billing system module 22 includes a work performed segment 250 and a web based segment 252, a data center 254, and an accounts payable segment 256. The segments are connected and allow the free transfer of information, such as billing data 258, submission of invoices 260 and payment information 262.

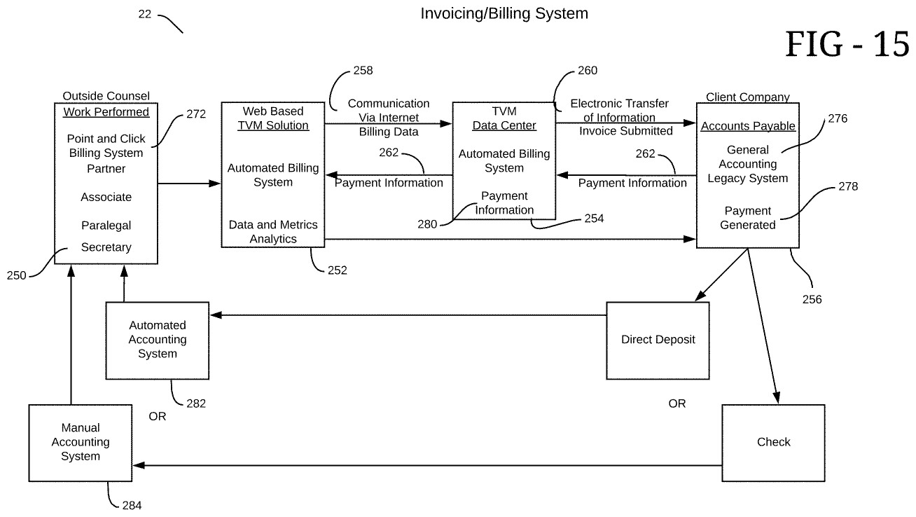

FIG. 16 is a flow diagram showing the steps outside counsel goes through in order to submit invoices to corporate counsel. To start the billing, the work performed segment 250, first, the attorney logs into the System and opens the home page 264. Once opened, the attorney selects the matter 266 on which work has been performed, reviews the screen and selects the description of the work which has been performed 268 by selecting the task completed by the attorney after selecting the matter, phase of the legal or regulatory matter and then the individual task. If the task has been completed, the attorney will select “complete” for the selected task 272. If corporate counsel has previously indicated that a task requires a document to be uploaded, the attorney will be prompted to attach a copy of the document in order to complete the task 272. Once the task marked as completed, the System 10 will prompt the attorney to confirm the date the task was completed and, if the System 10 identifies the fee arrangement as hourly, a space to enter the number of hours that the task took to complete if the task is based on an hourly fee arrangement 274. The System creates the description of the task, assigns a unique code for that task, identifies the fee arrangement for the task and identifies the biller. The outside counsel will have predetermined timeframe in which to submit invoices to corporate counsel. Once the predetermined timeframe is met (whether monthly, quarterly, semi-annually, etc.), then the attorney hits the submit invoice tab 276. Once outside counsel hits submit invoice 276, the System 10 will automatically create an invoice based on the pre-negotiated and agreed upon budget between corporate counsel and outside counsel for submission to corporate counsel 260. It will be appreciated that the invoice created can be for one additional task or the matter as a whole. The newly created invoice then goes to the corporation's general accounting system 276 where payment is generated 278 by either direct deposit, or by check. Information regarding the payment 262 is transmitted back through the data center 254 where it is processed and historical payment information 280 is generated. That payment information 262 is then sent back to the web segment 252 for distribution to the corporate counsel's automated accounting system 282 or a manual accounting system 284. Thus, outside counsel's accounting system 282 is capable of communicating via internet or some other electronic transfer means, for example satellite, to the corporation's accounting system 276. Thus, real time payment information 262 flows between the corporation and outside counsel, allowing either to have accurate information on payment status.

The data center 254 is operable to house all of the data for a particular client/company and acts as the hub for every law firm in the System 10 to funnel its billing and payment information through the data center 254. The data center 254 is operable to sort and generate the statistical reports for reporting module 26 and becomes a tool for corporate counsel to monitor all costs running through the System 10 from the phases to the individual tasks with everything being standardized to allow for accurate and direct comparisons.

The web segment 252 is the portal through which a particular law firm transmits its billing data to the company's data center 254, and it receives payment information 262 back from the data center 254. The point and click billing system 272 standardizes the inputting of the work that has been performed by simply clicking on the matter as discussed in FIG. 16 and then drilling down to the particular task that has been completed.

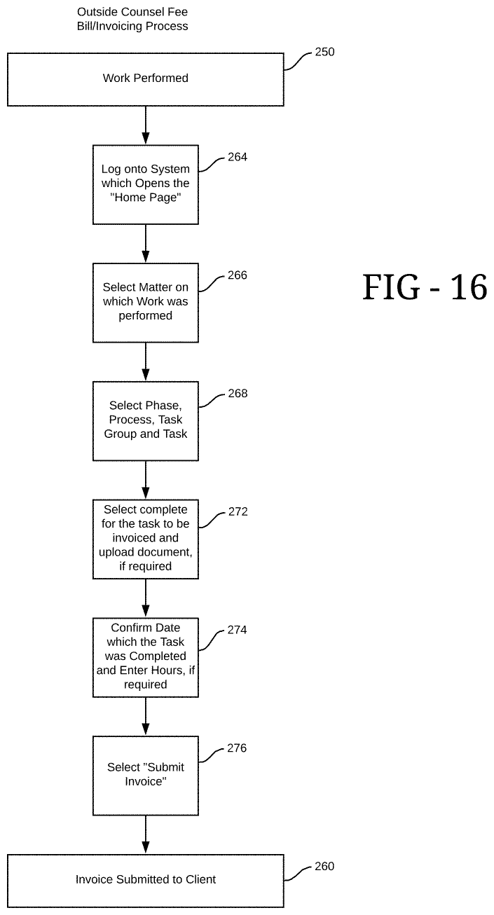

FIG. 17 illustrates a workflow diagram for outside counsel to enter into the System 10 the expenses 290 that have been incurred. First, outside counsel logs onto the system home page 292 and selects the matter that the expense occurred in 294. Next counsel selects the expense screen 296 from the tool bar or from a pull-down menu and selects the expense item 298 and enters the amount of the expense. The submit invoice button 300 is clicked on and then the attorney must make the decision as to whether the litigation guidelines require a receipt 302, and if so, then it will be submitted 304 to corporate counsel or retained 306, depending on the circumstances. If there is no retention policy on receipts then the expense invoice is submitted to the corporate counsel 308. The invoice created by the System 10 as discussed above is processed through the billing system module 22 as set forth in FIG. 15 and the payment is generated 278 as discussed above. The expense information is stored in the data center 254 for later statistical analysis and processing.

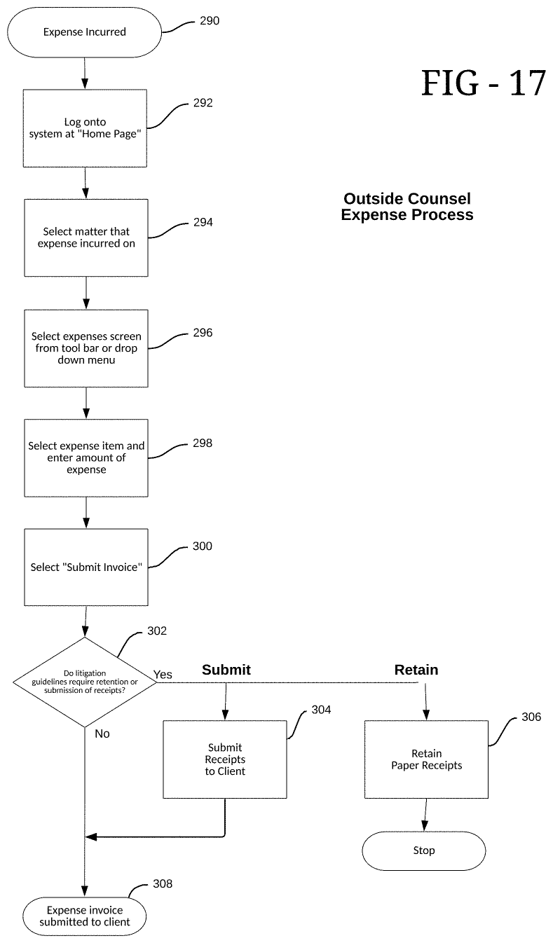

With reference to FIG. 18, the exceptions module 24 provides for modification of the existing case budget when a new, modified, or alternative tasks are to be performed. For example, an unplanned event during the course of litigation may arise as a result of the court issuing an unexpected order which requires additional action of outside counsel. In such an instance, an exception request 350 would be generated and outside counsel would log on to the system 352, click on the appropriate matter for the exception 354, click the appropriate coded budget item 356 and select a new, modified, or alternative task 358. It will be appreciated that the value of a task can be modified, for example if it adds an increase in value to a task that is already in the system. Outside counsel then selects the exception report icon 360 and fills in 362 the appropriate information in the fields and then selects the submit tab 364 for sending the exception request to corporate counsel.

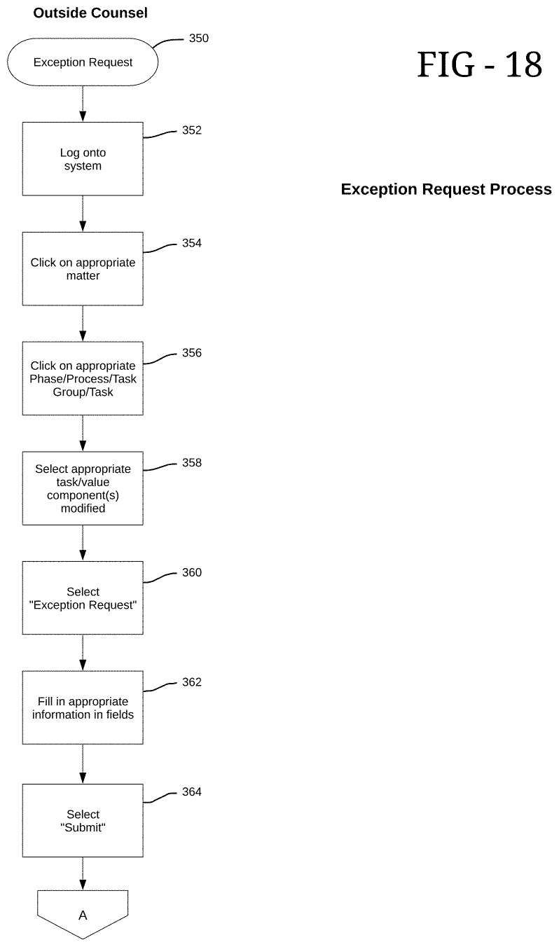

FIG. 19 illustrates the steps for processing the exception request from corporate counsel's viewpoint. Here corporate counsel opens the System 10 and selects the action items exception request button 366. The request is reviewed 368 and corporate counsel must now consider 370 as to whether to reject 372 the request, modify 374 the request, or to approve 376 the request. If corporate counsel approves the request by selecting the approve button 376, a communication is sent to outside counsel of her decision. Outside counsel then opens the home page 378 and selects the exception status tab 380 and reviews 382 the status of the request. Outside counsel then takes the appropriate action based upon the response 384 and completes the task, if authorized in full or authorized with limitations. The exception request process is now completed 386 and can now be billed utilizing the billing module 22 as discussed above. It will be appreciated that corporate counsel may create an automatic cost approval range and as long as outside counsel's request falls within that range, then the request can be automatically approved without the manual review of corporate counsel.

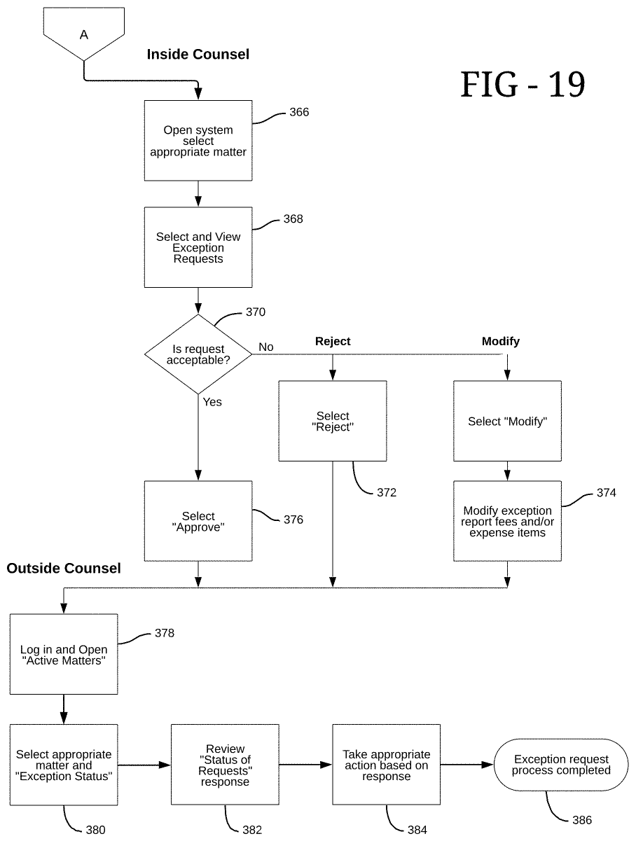

FIG. 20 illustrates an example screen output of what outside counsel and corporate counsel review when going through the exception request process as outlined in FIGS. 18 and 19.

FIG. 20 depicts the screen 400 corporate counsel sees after an exception request and review a summary of the exception request history and also includes the driver for the exception request. It will be appreciated that exception requests are only permitted to be submitted to corporate counsel within a client specified timeframe of completion of the task. This is also shown as review exception request 368 in the FIG. 19 diagram. Corporate counsel can now read outside counsel's narrative 368 of what has caused the exception and the recommended course of action. The cost of the new task is set out under the requested cost section 402 and it identifies the increase or decrease to the previously agreed to budget 404. At this time, corporate counsel can deny the request, approve the request or modify the request. It should be appreciated that corporate counsel has the ability to review the entire budget with approved changes and new totals by returning to the matter summary page or close the window or move to the next item. It should be appreciated that exception requests are not limited to hourly fee arrangements and can reflect value, hourly, flat, contingent or blended fee arrangements. They can also reflect a request for additional processes or task groups.

The statistical reporting module 26 is a tool used by corporate counsel in order to compare requests, current budget, and numerous other information that is stored in the date center 254.

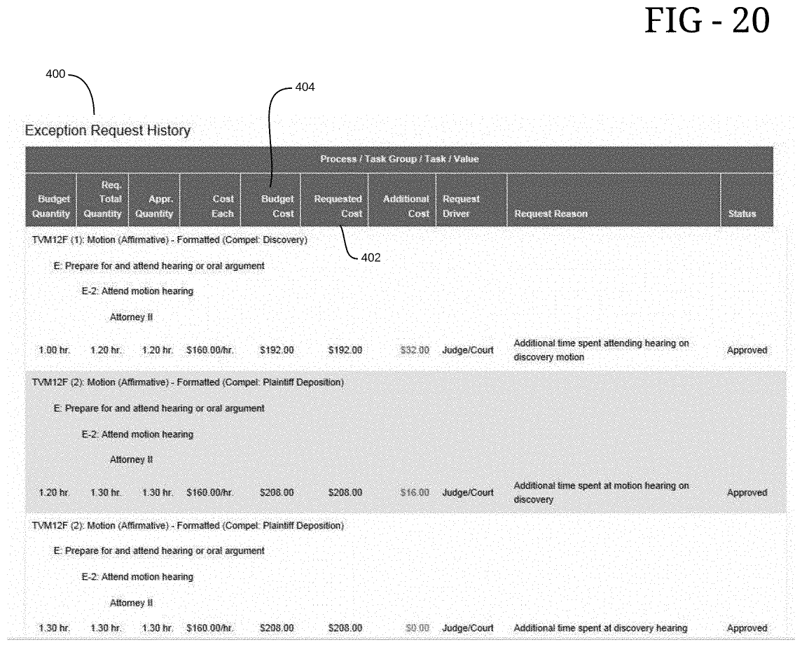

It will be appreciated that numerous other reports can be generated by the System 10. This is accomplished by clicking on a statistics tool bar and clicking on either standard reports or custom reports. Some of these standard reports include exception requests by region, exception requests that were granted by region, cost of exception requests by region and analysis of certain types of cases by specific law firms in certain regions of the country. Specific law firm data can be prepared to see which attorneys in a law firm are billing the most. A report can even be generated to find out specific fees and costs for a particular task or case. This and numerous other types of standard reports are available in the System 10 for corporate counsel to review. Examples of these additional reports are included as FIGS. 21-24.

FIG. 21 illustrates an example physical data output by a screen 420 as generated by the claimed invention showing a comparison report for an examination under oath—deposition which shows the amount budgeted 600 versus the amount invoiced 602 in an easy to view graphical representation. It should also be appreciated that FIG. 21 can also allow corporate counsel to view the age of a matter.

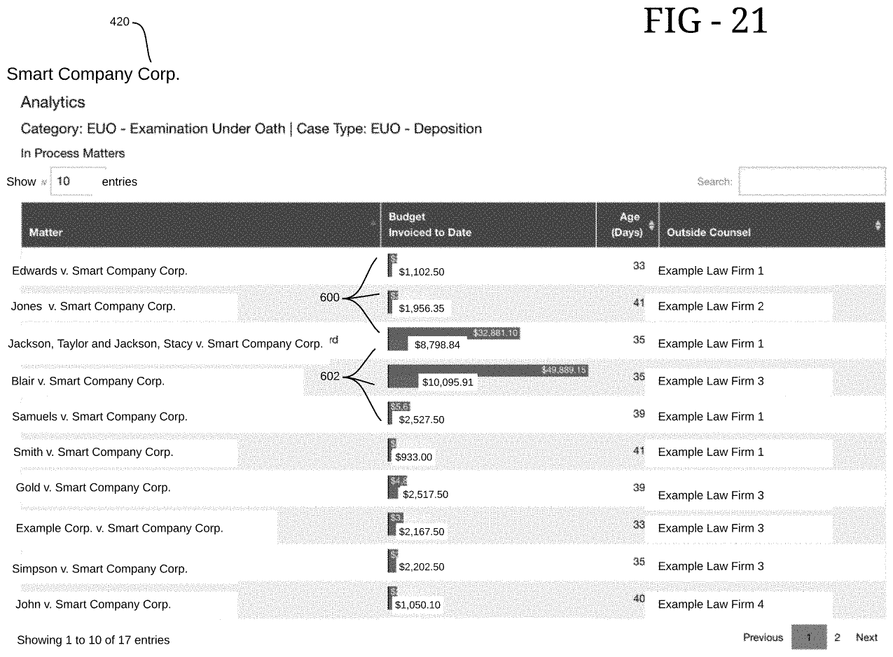

FIG. 22 illustrates physical data output by a screen 420 as generated by the claimed invention showing a comparison report 700 for different law firms for a specific phase of litigation for a personal injury matter in an easy to view graphical representation. This generation of data by the System 10 is not possible without the standardization created by the claimed invention. For example, FIG. 22 allows corporate counsel to quickly and easily compare an outside law firm's average billing amounts for all (PIP) 3^{rd} Party Actions in the Pre-trial Pleadings and Motion phase. Corporate counsel can then use this information in his or her determination of which outside counsel to use 150.

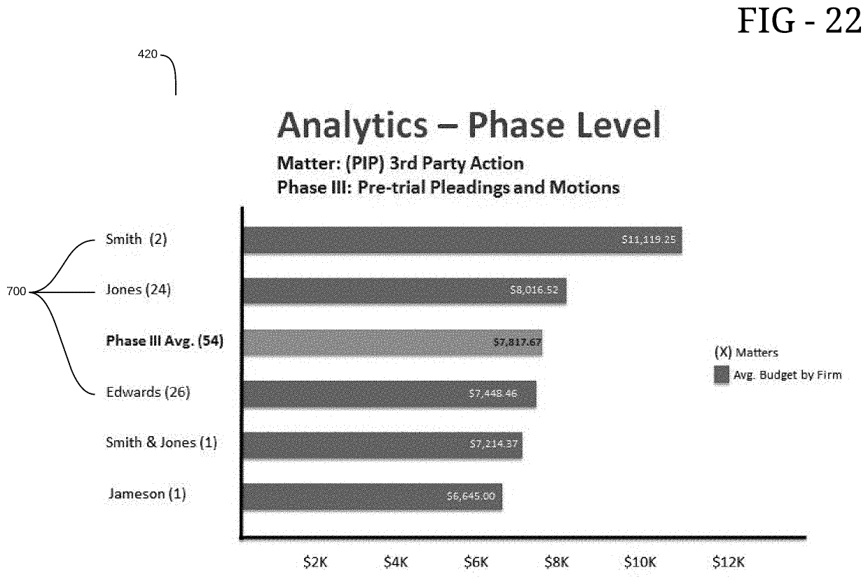

FIG. 23 illustrates physical data output by a screen 420 as generated by the claimed invention showing a comparison report 800 for different law firms for a specific process of litigation of a (PIP) 3^{rd} Party Action in an easy to view graphical representation. This generation of data by the System 10 is not possible without the standardization created by the claimed invention. For example, FIG. 23 would allow corporate counsel to quickly and easily compare an outside law firm's average billing amounts for a pre-trial motion to dismiss claim. Corporate counsel can then use this information in his or her determination of which outside counsel to use 150.

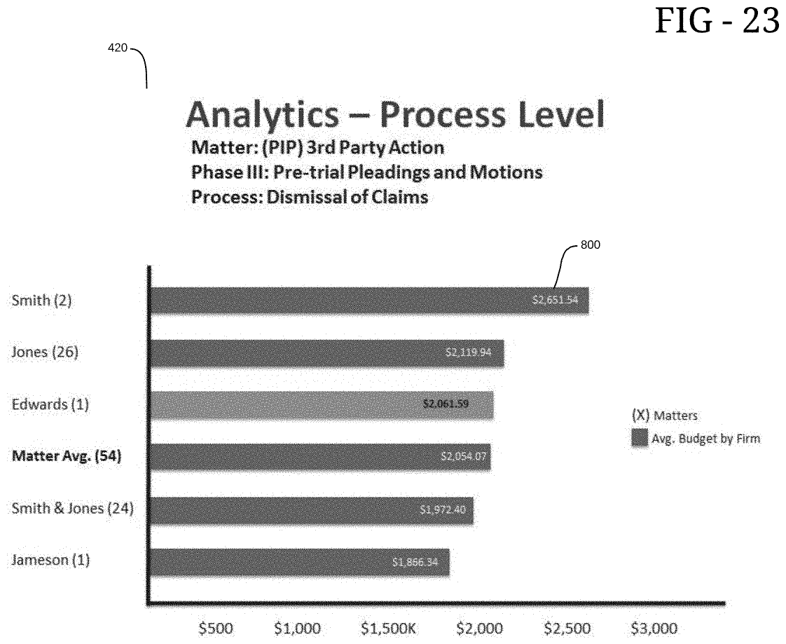

FIG. 24 illustrates physical data output by a screen 420 as generated by the claimed invention showing a comparison report 900 for different outside law firms for the specific task group of researching and drafting a motion for the dismissal of claims. This generation of data by System 10 down to the specific individual task group is not possible without the use of the claimed invention. Additionally, it will be appreciated that any of the processes, phases, task groups and tasks can be broken down into graphs and reports. The System 10 would be able to generate a statistical analysis based on any of the data collected and analyzed by the System 10 in real-time.

The incentives module 28 allows corporate counsel to reward law firms that provide exceptional services, for example, a law firm that creates a new strategy for handling a case that will save the company money. Further, outside counsel can be awarded a bonus when a winning motion is created that successfully terminates the case early. Because the System 10 controls the budget and it can be determined at any time where one is relative to the budget, a bonus can be easily determined. Thus, corporate counsel can reward a law firm for a new innovative approach. It should be appreciated by those skilled in the art that other variations to the preferred embodiments to the present invention, beyond those mentioned above, are possible. Accordingly, it is to be understood that the protection sought and to be afforded hereby should be deemed to extend to the subject matter defined by the claims to be filed with the non-provisional utility patent, including all varied equivalents thereof.

An additional feature of the System 10 is that it can calculate and then convert the set rate and value-based fees that are tracked by the System 10 and provide an hourly rate that in turn can be utilized for reporting on outside counsel's time sheets for outside counsel use. Thus, this provides outside counsel with a metric so that they can ascertain the effective hourly rate for the tasks being performed for a particular project.

The System 10 further has a feature that can capture task codes that may be utilized by the outside counsel and match those task codes to particular documents. The documents then can be matched in order to ensure performance by the outside counsel. The System 10 further is operable to once the documents have been matched to specific task codes, transfer those documents to the document repository which matches the document to the appropriate task within the System. Transfer of the documents can be made prior to the invoice being submitted. This provides a check in the invoicing system and an alert can be provided to the outside counsel to electronically attach the work product which has been completed and/or document which the client has requested to review. This process ensures a timely upload of documents on or around the time period in which a particular task code has been completed. This further assures that documents are electronically filed in an organized and logical manner so that document retrieval at a later date may be quickly and efficiently accomplished. This System ensures that documents will not be “misfiled” within the electronic document repository.

Another aspect of the System 10 is to create budgeting templates that match categories and case types. By creating budgeting templates, a budget library can be generated which enables corporate counsel to quickly and accurately create a budget for a particular new matter. Once a particular template has been chosen by corporate counsel, the System 10 will then calculate the budget including individual tasks that may need to be performed to effectively handle the matter. Those individual tasks are previously selected by virtue of the template having such tasks already in place.

Another aspect of the System 10 is that the System 10 can create an approximation of hours spent by an attorney from a flat fee, value fee, or contingent fee for use by the outside counsel's firm in order to determine the total hours which outside counsel spent on the matter for use in determining if the outside counsel met the firm's annual hour and/or billing requirements.

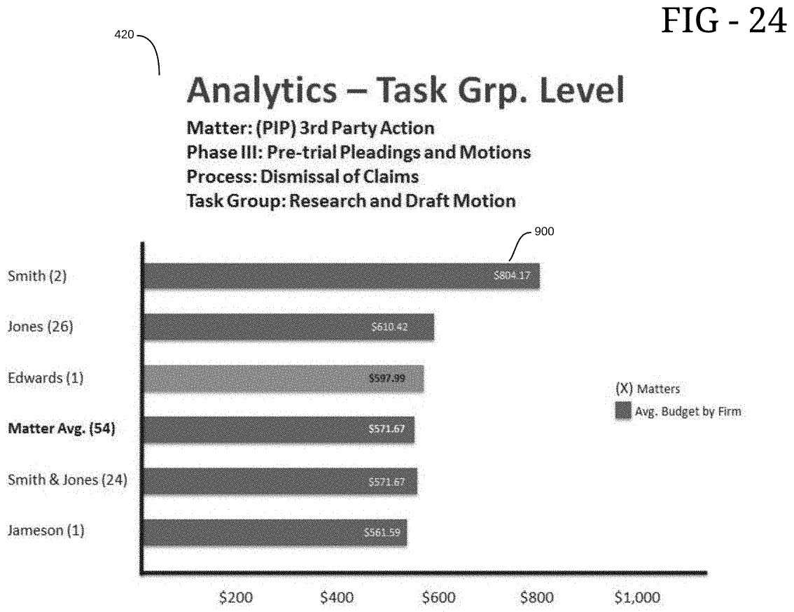

FIG. 25 illustrates the System 10 being used in a cloud computing system 1000 where a client 1002 interfaces with outside counsel 1004 while utilizing the cloud 1006. The cloud 1006 can be broadly interpreted to include, but not be limited to, a storage capacity for data, information, software, applications, etc. in a secured community. Such information and the like may be also stored on remote servers that are offsite from the client 1002 and/or the outside counsel 1004 and can be housed by a third party on a private server. The client 1002 could be a corporation, an insurance company, or another who has legal tasks that need to be performed. The exchange of information and the like in this cloud computing system 1000 can be conducted by a client 1002 inputting signals along input path 1008 into the cloud 1006. Data 1016 can be processed, manipulated in the cloud and then directed through the cloud 1006 via an output signal path 1010 and be directed to outside counsel 1004. Outside counsel 1004 may then interface with the client 1002 by processing an input signal which transmits along path 1012 which leads to the cloud 1006 whereby information, data, or the like is then transmitted via an output signal path 1014 to the client 1002. Thus, instead of information 1016 being transmitted directly from outside counsel 1004 to client 1002, the cloud 1006 can act as an intermediary.

This improved legal service task value management cloud computing system 1000 interfaces with a computer, modules that utilize maps, modules for assigning dollar values for tasks, and modules for inputting pre-approved dollar values for each associated task. The cloud based legal task value management system 1000 is operable to allow a user to select at least one process map, variables for individual tasks to be done, establish a budget for each task, provide a case status module, and provide a point and click building module. The cloud based system 1000 further can be utilized to include real time analysis module, a real time budget and cost to complete module, and an exceptions module. It will be further appreciated that the cloud based system 1000 can be used with a law firm for managing the cost of legal services including the steps of corporate counsel generating a working budget, the budget being submitted to the law firm through the cloud 1006, the budget being considered by the law firm or outside counsel 1004, the outside counsel 1004 then performing the budgeted legal service, and then the legal firm electronically requesting payment or possible exceptions when the task is outside of the agreed upon budget.

The Systems 10 and 1000 are operable to operate on a variety of computers, including, but not limited to, macs, smart phones, tablets, desktops, laptops, and other computing devices. It will be appreciated that the cloud computing system 1000 can employ other features and methodologies which are within the fair scope of the present invention and output screens may be modified within the fair scope of the present invention for appropriate technological display on any variety of computer which is using the System 10.

It will be appreciated that the aforementioned process and devices may be modified to have some steps removed, or may have additional steps added, all of which are deemed to be within the spirit of the present invention. Even though the present invention has been described in detail with reference to specific embodiments, it will be appreciated that various modifications and changes can be made to these embodiments without departing from the scope of the present invention. Accordingly, the specification and the drawings are to be regarded as an illustrative thought instead of merely a restrictive thought of the scope of the present invention.

1. A computer based method that allows a client to control and manage the cost and activity of a legal service comprising:
selecting at least one process map, each process map consisting of at least one phase, each phase consisting of at least one task to be done in a legal service;
setting variables for each individual task to be done in the legal service;
establishing a budget for each task which an outside counsel must follow;
providing a case status module with information on how the legal service is proceeding based upon tasks performed to date;
providing a point and click billing module for automatic creation of an invoice from the budget; and
submitting the invoices to the client, the invoices having amounts that equal the value variables for the tasks that have been performed.

2. The method as claimed in claim 1, wherein the task requires submission of a document prior to completion of the task.

3. The method as claimed in claim 1, wherein the legal service is a law suit.

4. The method as claimed in claim 1, wherein the legal service is a regulatory matter.

5. The method as claimed in claim 1, further comprising the step of providing statistical reporting to the client.

6. The method claimed in claim 1, wherein the step of selecting process maps includes selecting each anticipated task of the legal service.

7. The method as claimed in claim 1, wherein the step of creating process maps includes identifying each individual task to be performed in the legal service.

8. The method as claimed in claim 7, wherein the step of creating process maps includes identifying alternative tasks to be performed in the legal service.

9. The method as claimed in claim 1, wherein the step of setting variables includes the client establishing limits for each task to be performed.

10. The method as claimed in claim 9, wherein the limits for each task performed are a fee structure.

11. The method as claimed in claim 10, wherein the fee structure is a flat fee.

12. The method as claimed in claim 10, wherein the fee structure is a contingency fee.

13. The method as claimed in claim 10, wherein the fee structure is an hourly fee.

14. The method as claimed in claim 10, wherein the fee structure is a value fee.

15. The method as claimed in claim 10, wherein the limits for each task performed contains an upper control limit.

16. The method as claimed in claim 1, wherein the step of establishing a budget includes the client generating values for each individual task, the client electronically submitting the budget to outside counsel, and the outside counsel either accepting or rejecting the budget by a submission back to the client.

17. The method as claimed in claim 1, wherein the step of providing a profile status module includes providing a client with current information on status of a particular legal service by transmission of such information over the internet.

18. The method as claimed in claim 1, wherein the step of providing an exceptions module includes allowing outside counsel to electronically submit requests for approval of new work.

19. The method as claimed in claim 5, wherein the step of providing statistical reporting includes graphically outputting information based on data that is generated by said method.

20. The method as in claim 1, further comprising a computer module that calculates and then converts a value based fee variable to an hourly rate variable.

21. The method as in claim 1, further comprising a module that captures task codes that have been completed and matches said task codes to documents generated by counsel performing legal tasks.

22. The method as in claim 1, further comprising a module that captures an expense that relates to a task code that have been completed and matches said expense to said task code performed by counsel performing tasks.

23. The method as in claim 1, further comprising the step of providing a budget template.

24. The method as in claim 1, further comprising the step of providing an analysis of a cost value factor.

25. A client controlled legal cost management system comprising:
a computer that is operable to process one or more of the following modules:
a module that maps out in detail legal service variables;
a module for assigning dollar values to each task of the process;
a module for inputting pre-approved dollar values for each task to be charged by counsel; and
a module for the creation of an invoice from the pre-approved dollar values for each task to be charged by counsel.

26. A computer based cost control and management system for assisting corporate counsel in managing legal costs comprising:
a real time analysis module that is operable to inform corporate counsel of legal cost;
a real time budget and cost to complete module; and
an exception module that is operable to permit outside counsel to request to modify the budget.

27. A system of a law firm and a first party managing the cost of legal services comprising:
a first party generating an actual working budget;
the actual budget being electronically submitted to a law firm by using a computer;
the budget being considered by the law firm;
a legal service be completed based upon an agreed upon budget;
the law firm electronically requesting exceptions when a task is outside of the agreed upon budget; and
an invoice being created from the budget.
